(19) United States
(12) Patent Application Publication
(10) Pub. No.: US 2018/0241916 A1
(43) Pub. Date: Aug. 23, 2018

(54) 3D SPACE RENDERING SYSTEM WITH MULTI-CAMERA IMAGE DEPTH

(71) Applicant: National Central University, Taoyuan City (TW)

(72) Inventors: Yeh-Wei YU, Taoyuan City (TW); Hu-Mu CHEN, Taoyuan City (TW); Li-Ching WU, Taoyuan City (TW); Ching-Cherng SUN, Taoyuan City (TW); Tsung-Hsun YANG, Taoyuan City (TW); Yi-Chieh CHANG, Taoyuan City (TW)

(73) Assignee: NATIONAL CENTRAL UNIVERSITY

(21) Appl. No.: 15/903,265

(22) Filed: Feb. 23, 2018

Related U.S. Application Data
(60) Provisional application No. 62/462,547, filed on Feb. 23, 2017.

(51) Int. Cl. H04N 5/225; H04M 1/02; G06T 15/20

(52) U.S. Cl. CPC H04N 5/2252; G06T 15/205; H04M 1/0264; H04N 13/0239

(57) ABSTRACT

A 3D space rendering system with multi-camera image depth includes a headset and a 3D software. The headset includes a body with a first support and a second support. The 3D software is in electrical signal communication with a first image capturing device and a second image capturing device. The system makes it possible to establish 3D image models at low cost, thereby allowing more people to create such models faster.

### BACKGROUND OF THE INVENTION

### 1. Technical Field

The present invention relates to a three-dimensional (3D) space rendering system with multi-camera image depth. More particularly, the invention relates to a 3D space rendering system with multi-camera image depth that uses two smartphones to capture images and that enables rapid establishment of 3D models.

### 2. Description of Related Art

Analytics of 3D spatial information compensates for the deficiencies of two-dimensional spaces and adds a new dimension to planar presentation. An object presented in 3D—be it the interior of a building, a streetscape, or a disaster prevention map—can be visually perceived in a more intuitive manner.

In the matter of model establishment for future digital cities, the construction of a required information architecture can be divided into the modeling of buildings, which is tangible, and the compilation of intangible building attributes. Information for the former can be converted into models by processes involving vector maps, digital images, LiDAR, and/or the point cloud modeling technique.

Once a virtual building or other object takes shape, it can be rendered realistic by texture mapping as well as by direct use of color pictures, with a view to esthetic enhancement and greater ease of identification. The completed 3D model can be effectively used and be considered together with issues like costs and practical needs to facilitate decision-making regarding the degree to which the planned system is to be built.

### BRIEF SUMMARY OF THE INVENTION

The present invention provides a 3D space rendering system featuring multi-camera image depth. The system is intended primarily to solve the problem that the popularization and ease of 3D model establishment have been hindered by costly equipment.

The present invention provides a three-dimensional space rendering system with multi-camera image depth, comprising: a headset comprising a body, wherein the body is formed with a first support and a second support; and a 3D software in electrical signal communication with a first image capturing device and a second image capturing device.

Implementation of the present invention at least produces the following advantageous effects:

1. 3D models can be established at low cost; and

2. 3D models can be established rapidly.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

FIG. 1 is a perspective view showing the structure of a system according to the present invention;

FIG. 2 is an exploded view of a headset according to the present invention;

FIG. 3 is a front perspective view of a headset according to the present invention;

FIG. 4 is a rear perspective view of the headset in FIG. 3;

FIG. 5A shows a headset according to the present invention that has a fine-tuning mechanism;

FIG. 5B shows another headset according to the present invention that has a fine-tuning mechanism;

FIG. 5C shows a headset according to the present invention that has a resilient mechanism;

FIG. 6A shows a headset according to the present invention that has a partition plate;

FIG. 6B is a sectional view of the headset in FIG. 6A;

FIG. 6C shows another headset according to the present invention that has a partition plate;

FIG. 6D is a sectional view of the headset in FIG. 6C;

FIG. 7A shows a headset according to the present invention that has a projection light source;

FIG. 7B is a sectional view of the headset in FIG. 7A;

FIG. 8 shows the process flow of a piece of a 3D software according to the present invention;

FIG. 9 is the flowchart of the process flow in FIG. 8; and

FIG. 10 is similar to FIG. 8, showing in particular the overlaps between images and between feature points.

### DETAILED DESCRIPTION OF THE INVENTION

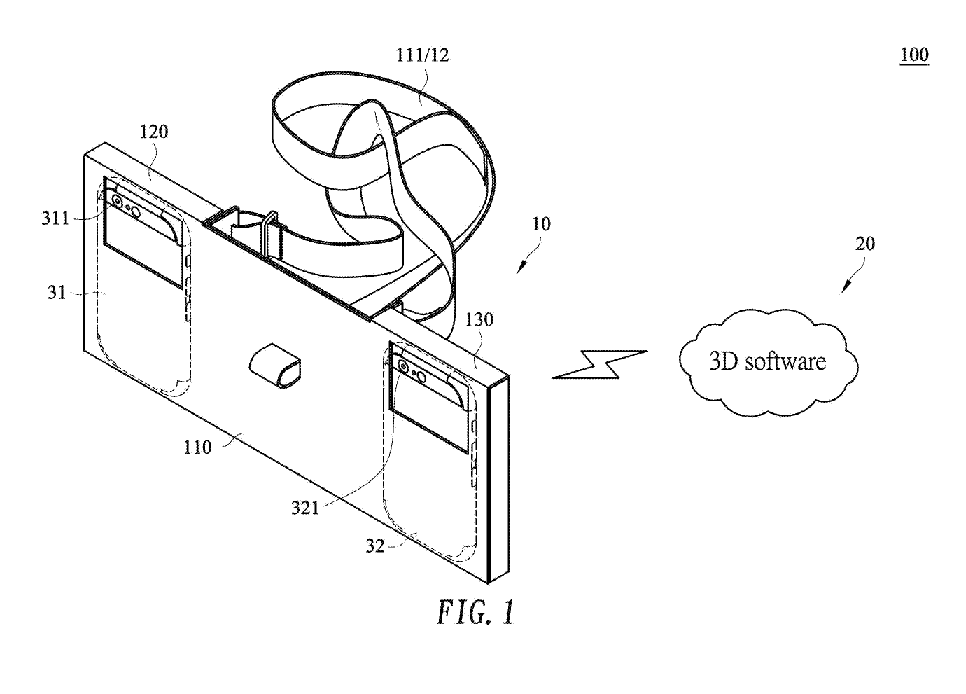

According to an embodiment of the present invention as shown in FIG. 1, a 3D space rendering system 100 with multi-camera image depth includes a headset 10 and a 3D software 20. The headset 10 includes a body 110, a first support 120, and a second support 130.

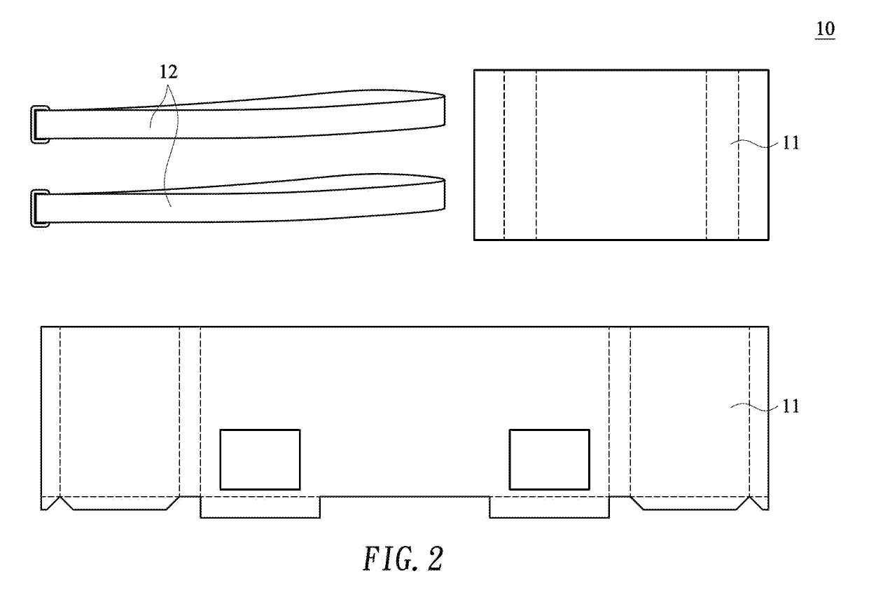

The headset 10 is made of a material capable of providing adequate support, such as a paper-based or plastic material. To make the headset 10 out of a paper-based material, referring to FIG. 2, cardboard 11 is folded and assembled into the shape of the headset 10 and then coupled with straps 12. This approach is low-cost, facilitates production, and results in highly portable products.

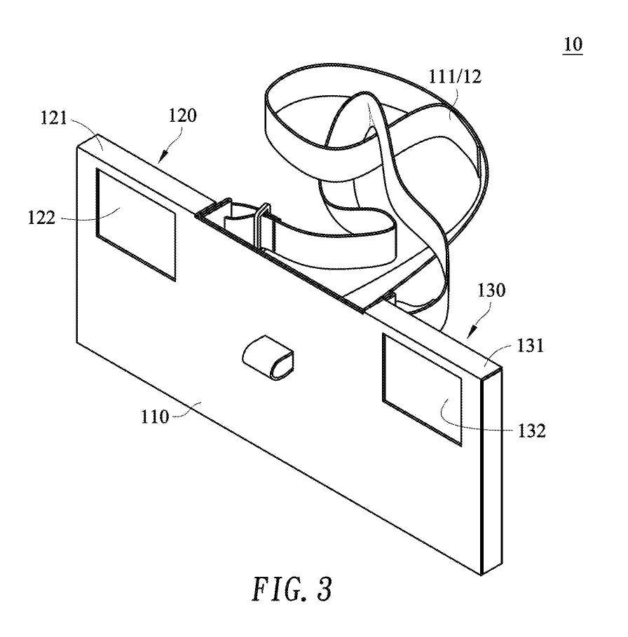

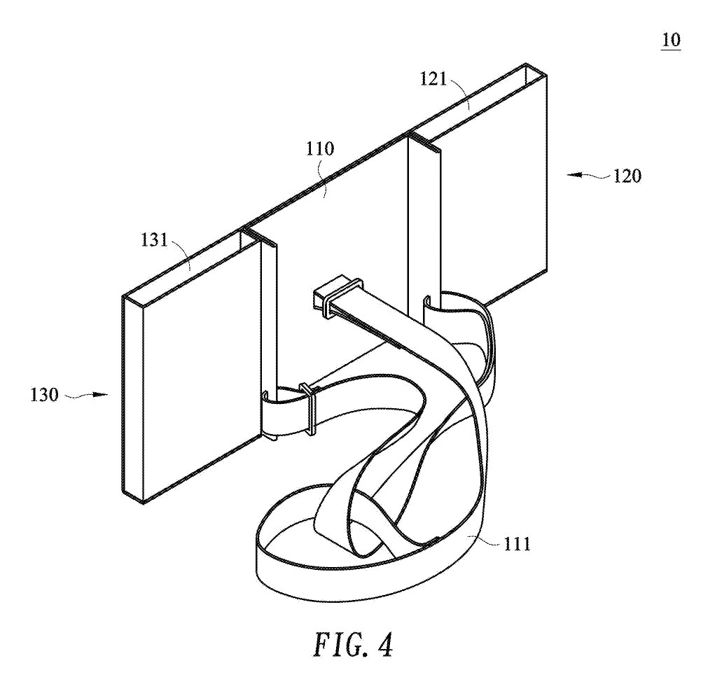

As shown in FIG. 3 and FIG. 4, the body 110 is the main supporting frame of the headset 10 and serves to support the first support 120 and the second support 130. The body 110 is provided with a fixing member 111, such as the straps 12, so that the headset 10 can be worn firmly on a user's head.

The first support 120 is formed on one lateral side of the body 110 and has a first receiving space 121 or a first window 122. The first receiving space 121 is configured for receiving a first image capturing device 31. The first window 122 is configured to enable the lens of the first image capturing device 31 to capture images through the first window 122.

The second support 130 is formed on the opposite lateral side of the body 110 such that the first support 120 and the second support 130 are symmetrically arranged. The second support 130 has a second receiving space 131 or a second window 132. The second receiving space 131 is configured for receiving a second image capturing device 32. The second window 132 is configured to enable the lens of the second image capturing device 32 to capture images through the second window 132.

The first image capturing device 31 and the second image capturing device 32 may be mobile phones with photographic functions and optionally with wireless transmission capabilities.

Apart from supporting the first image capturing device 31 and the second image capturing device 32 respectively, the first support 120 and the second support 130 help fix the distance between, and the directions of, the lenses of the first image capturing device 31 and of the second image capturing device 32 in order to define important parameters of the two image capturing devices 31 and 32 in relation to each other. These parameters form the basis of subsequent computation by the 3D software 20 concerning the first image capturing device 31 and the second image capturing device 32.

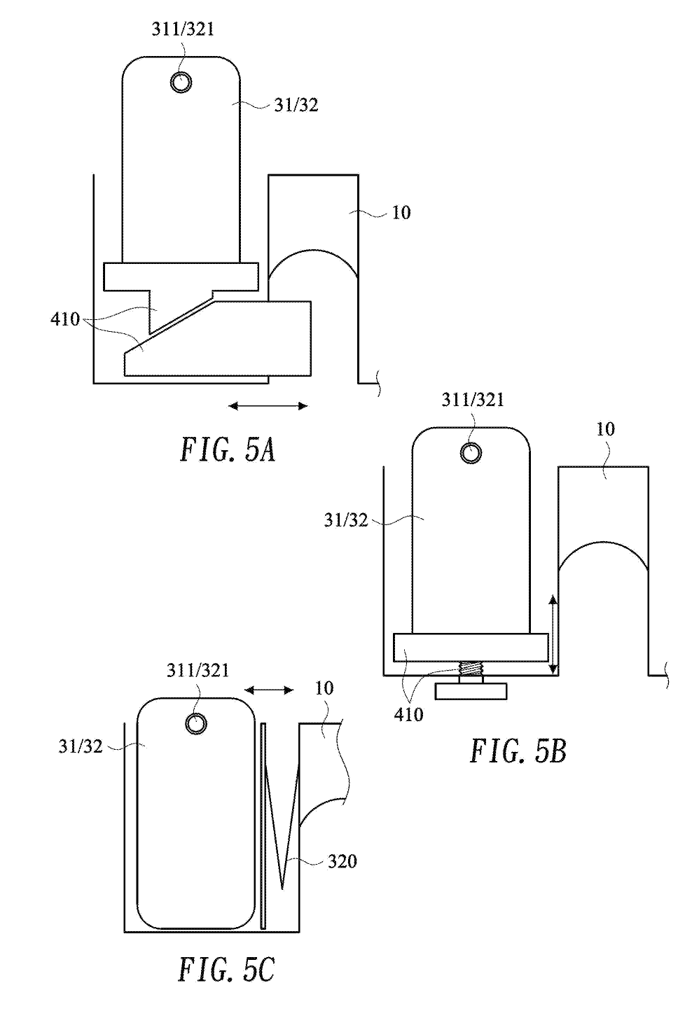

Referring to FIG. 5A and FIG. 5B, the headset 10 may further have a fine-tuning mechanism 410 to help fix the distance between, and the directions of, the lenses 311 and 321 of the first image capturing device 31 and of the second image capturing device 32. The fine-tuning mechanism 410 can be used to adjust the first image capturing device 31 and the second image capturing device 32 horizontally and/or vertically so that the two image capturing devices 31 and 32 are at the same height.

As shown in FIG. 5C, the headset 10 may further have a resilient mechanism 320 for pressing mobile phones tightly against the first support 120 and the second support 130 respectively.

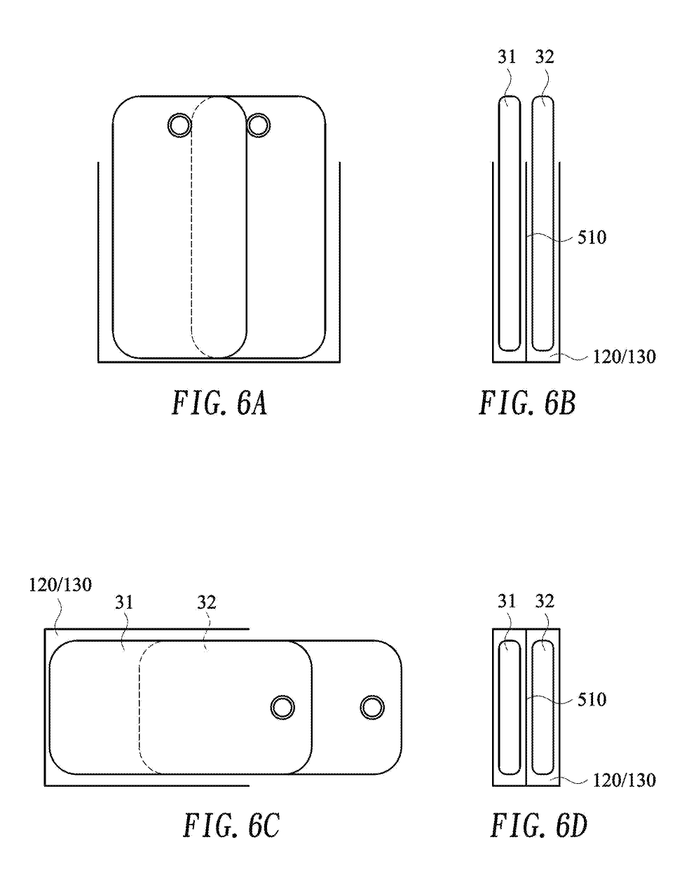

In cases where the first support 120 and the second support 130 are in communication with each other, referring to FIG. 6A to FIG. 6D, a partition plate 510 is provided to allow the first image capturing device 31 and the second image capturing device 32 to be arranged in such a way that they overlap each other, which adds flexibility to the image capturing angles of the first image capturing device 31 and of the second image capturing device 32.

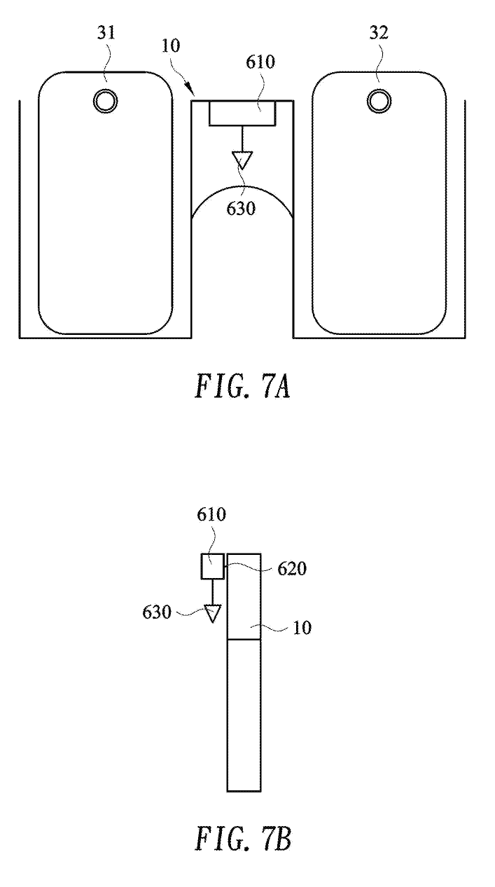

Referring to FIG. 7A and FIG. 7B, the headset 10 may be shaped to resemble a pair of glasses so as to be worn on a user's face with ease. The headset 10 may be further provided with a projection light source 610 for projecting structured light having a specific pattern or specific lines. The projection light source 610 may be connected to the headset 10 by a rotating shaft 620. In addition, the projection light source 610 may be attached with a pendulum 630 in order for the projected image to convey horizontality information.

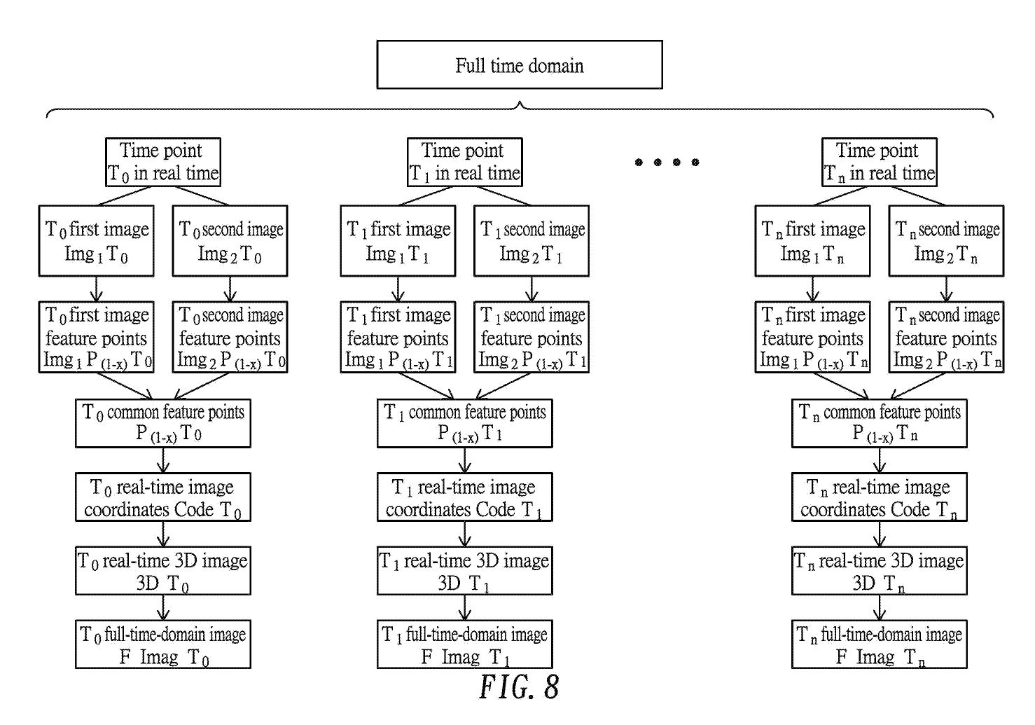

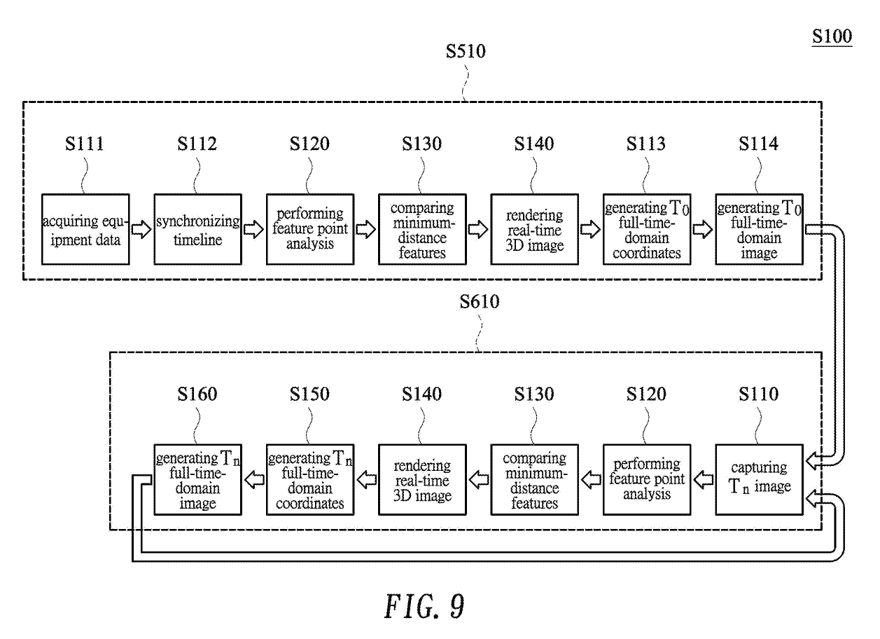

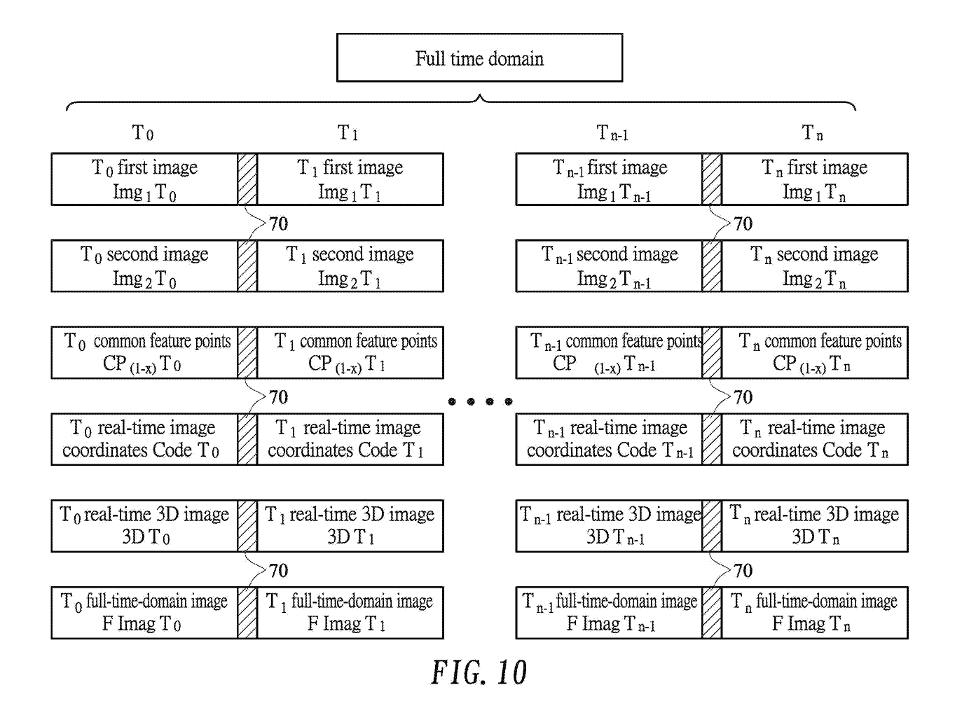

To apply the foregoing embodiment to the rendering of 3D spaces, referring to FIG. 8 to FIG. 10, the first image capturing device 31 is put into the first support 120, and the second image capturing device 32, into the second support 130. Then, the headset 10 is worn on the user's head to capture images, with the target whose image is to be captured being changed continuously. More specifically, as time progresses from time point T₀ to time point Tₙ along their respective timeline, the first image capturing device 31 and the second image capturing device 32 keep capturing images of the changing targets simultaneously to obtain plural sets of first image capturing device images Imag₁ and plural sets of second image capturing device images Imag₂.

The 3D software 20 is in electrical signal communication with the first image capturing device 31 and the second image capturing device 32 in order to control, and read information from, the first image capturing device 31 and the second image capturing device 32.

The 3D software 20 may be in electrical signal communication with the first image capturing device 31 and the second image capturing device 32 via Bluetooth, WiFi, or NFC. In addition to image information, the 3D software 20 reads from the two image capturing devices 31 and 32 gravity sensor data for calculation of space, GPS data to facilitate calculation of space and positions, and gyroscope detection result to obtain horizontality information of the first image capturing device 31 and of the second image capturing device 32.

To enhance precision of computation, errors associated with the timeline can be controlled to be less than or equal to 50 microseconds (ms). Moreover, the 3D software 20 synchronizes the images of the first image capturing device 31 and of the second image capturing device 32 by calculating the time difference between the clocks of the two image capturing devices 31 and 32 and then correcting the time of the images of the two image capturing devices 31 and 32 accordingly. All the information may be computed in a fog computing system to accelerate the obtainment of 3D information.

The process flow S100 of the 3D software 20 can be divided into two major steps, initializing (S510) and generating full-time-domain images (S610).

The step of initializing (S510) is performed at time point T₀ to synchronize image coordinates of at least a T₀ first image Img₁T₀ of the first image capturing device 31 and of at least a T₀ second image Img₂T₀ of the second image capturing device 32 and to generate T₀ real-time image coordinates CodeT₀ and T₀ full-time-domain coordinates FCodeT₀. The step of initializing (S510) includes the sub-steps of: acquiring equipment data (S111), synchronizing timeline (S112), performing feature point analysis (S120), comparing minimum-distance features (S130), rendering a real-time 3D image (S140), generating full-time-domain coordinates (S113), and generating a full-time-domain image (S114).

The sub-step of acquiring equipment data (S111) is to acquire the equipment data of the first image capturing device 31 and of the second image capturing device 32. The equipment data may be mobile phone data. More specifically, a database containing mobile phone data of various brands and various models is created in advance, and important parameters of each mobile phone to be used are acquired from the database to facilitate subsequent computation. For example, the equipment data may include the brands, model numbers, lens dimensions, and shell dimensions of the mobile phones to be used and the distance from each lens to the corresponding shell.

The sub-step of synchronizing the timeline (S112) is to synchronize the system timeline of the first image capturing device 31 and of the second image capturing device 32 so as to establish a common basis for subsequent image computation.

The sub-step of performing feature point analysis (S120) is to read the T₀ first image Img₁T₀ of the first image capturing device 31 and the T₀ second image Img₂T₀ of the second image capturing device 32, analyze the feature points (e.g., by Scale-Invariant Feature Transform, SIFT), and generate a plurality of T₀ first feature points Img₁P_{(1-X)}T₀ of the T₀ first image and a plurality of T₀ second feature points Img₂P_{(1-X)}T₀ of the T₀ second image.

The sub-step of comparing minimum-distance features (S130) is to compare the distances from each of the T₀ first feature points Img₁P_{(1-X)}T₀ to all the T₀ second feature points Img₂P_{(1-X)}T₀ and find the T₀ second feature point Img₂P_{X}T₀ closest to (i.e., having the smallest distance from) any given T₀ first feature point Img₁P_{X}T₀. Each pair of T₀ first feature point Img₁P_{X}T₀ and T₀ second feature point Img₂P_{X}T₀ that are found to have the smallest distance therebetween are determined to be the same feature point, i.e., a T₀ real-time common feature point CP_{X}T₀. As comparison continues, a plurality of T₀ real-time common feature points CP_{(1-X)}T₀ are generated. These T₀ real-time common feature points CP_{(1-X)}T₀ are then used to create T₀ real-time image coordinates CodeT₀.

The sub-step of comparing minimum-distance features (S130) may carry out feature point matching by the Nearest Neighbor method, and erroneously matched features points can be eliminated by RANSAC. Thus, common objects (i.e., the real-time common feature points CP_{(1-X)}T₀) in images captured at the same time by both the first image capturing device 31 and the second image capturing device 32 point are obtained.

After obtaining the T₀ real-time common feature points CP_{(1-X)}T₀ at T₀, distances between corresponding feature points are calculated by a distance calculation method to obtain the depth information of plural objects. The depth information provides parameters for the subsequent rendering sub-step.

In the sub-step of rendering a real-time 3D image (S140), the T₀ real-time common feature points CP_{(1-X)}T₀ and the T₀ real-time image coordinates CodeT₀ are used to generate a T₀ real-time 3D image 3DT₀.

The sub-step of generating T₀ full-time-domain coordinates (S113) includes using one of the first image capturing device 31 and the second image capturing device 32 as T₀ real-time 3D position information (or more particularly, using the position of the first image capturing device 31 or the second image capturing device 32 at the image capturing moment as the full-time-domain coordinate origin (0, 0, 0)) and cross-referencing the full-time-domain origin to the T₀ real-time common feature points CP_{(1-X)}T₀ and the T₀ real-time image coordinates CodeT₀ in order to generate the T₀ full-time-domain coordinates FCodeT₀ together with the full-time-domain reference point and full-time-domain reference directions of the T₀ full-time-domain coordinates FCodeT₀.

The sub-step of generating a T₀ full-time-domain image (S114) includes incorporating the T₀ real-time common feature points CP_{(1-X)}T₀ and the T₀ real-time 3D image 3DT₀ into the T₀ full-time-domain coordinates FCodeT₀ to generate a T₀ full-time-domain image FImagT₀.

The step of generating full-time-domain images (S610) includes the sub-steps, to be performed at each time point from time point T₁ to time point Tₙ, of: capturing a Tₙ image (S110), performing feature point analysis (S120), comparing minimum-distance features (S130), rendering a real-time 3D image (S140), generating Tₙ full-time-domain coordinates (S150), and generating a Tₙ full-time-domain image (S160).

The sub-step of capturing a Tₙ image (S110) uses the first image capturing device 31 and the second image capturing device 32 to capture a Tₙ first image Img₁Tₙ of the first image capturing device 31 and a Tₙ second image Img₂Tₙ of the second image capturing device 32 at time point Tₙ.

The sub-step of performing feature point analysis (S120) is to read the Tₙ first image Img₁Tₙ and the Tₙ second image Img₂Tₙ and generate a plurality of Tₙ first feature points Img₁P_{(1-X)}Tₙ of the Tₙ first image and a plurality of Tₙ second feature points Img₂P_{(1-X)}Tₙ of the Tₙ second image.

The sub-step of comparing minimum-distance features (S130) is to compare the distances from each of the Tₙ first feature points Img₁P_{(1-X)}Tₙ to all the Tₙ second feature points Img₂P_{(1-X)}Tₙ and find the Tₙ second feature point Img₂P_{X}Tₙ closest to (i.e., having the smallest distance from) any given Tₙ first feature point Img₁P_{X}Tₙ. Each pair of Tₙ first feature point Img₁P_{X}Tₙ and Tₙ second feature point Img₂P_{X}Tₙ that are found to have the smallest distance therebetween are determined to be the same feature point. As comparison continues, a plurality of Tₙ real-time common feature points CP_{(1-X)}Tₙ are generated, followed by Tₙ real-time image coordinates CodeTₙ.

In the sub-step of rendering a real-time 3D image (S140), the Tₙ real-time common feature points CP_{(1-X)}Tₙ and the Tₙ real-time image coordinates CodeTₙ are used to generate a Tₙ real-time 3D image 3DTₙ. The sub-step of rendering a real-time 3D image (S140) may involve the use of an extended Kalman filter (EKF) to update the positions and directions of the image capturing devices and to render the image, wherein the image may be a map or a perspective drawing of a specific space, for example.

The sub-step of generating Tn full-time-domain coordinates (S150) is explained as follows. When the first image capturing device 31 and the second image capturing device 32 capture images, there is an overlap 70 between the Tₙ first image Img₁Tₙ and the Tₙ₋₁ first image Img₁Tₙ₋₁ and also between the Tₙ second image Img₂Tₙ and the Tₙ₋₁ second image Img₂Tₙ₋₁. Hence, there is an overlap 70 between the Tₙ real-time common feature points CP_{(1-X)}Tₙ and the Tₙ₋₁ real-time common feature points CP_{(1-X)}Tₙ₋₁ and consequently between the Tₙ real-time 3D image 3DTₙ and the Tₙ₋₁ real-time 3D image 3DTₙ₋₁.

Thanks to the foregoing overlap feature, the Tₙ real-time device position information of the image capturing devices at time point Tₙ can be cross-referenced to the Tₙ real-time common feature points CP_{(1-X)}Tₙ and the Tₙ real-time image coordinates CodeTₙ and then integrated with the Tₙ₋₁ full-time-domain coordinates FCodeTₙ₋₁ at time point Tₙ₋₁ to generate Tₙ full-time-domain coordinates FCodeTₙ.

The sub-step of generating a Tₙ full-time-domain image (S160) includes incorporating the Tₙ real-time common feature points CP_{(1-X)}Tₙ and the Tₙ real-time 3D image 3DTₙ into the Tₙ full-time-domain coordinates FCodeTₙ to generate a Tₙ full-time-domain image FImagTₙ.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A three-dimensional (3D) space rendering system with multi-camera image depth, comprising:
a headset comprising a body, wherein the body is formed with a first support and a second support; and
a 3D software in electrical signal communication with a first image capturing device and a second image capturing device.

2. The 3D space rendering system of claim 1, wherein the headset is made of a paper-based or plastic material.

3. The 3D space rendering system of claim 1, wherein the body is further provided with a fixing member.

4. The 3D space rendering system of claim 1, wherein the first support is formed on a lateral side of the body and has a first receiving space.

5. The 3D space rendering system of claim 4, wherein the second support is formed on an opposite lateral side of the body such that the first support and the second support are symmetrically arranged, and the second support has a second receiving space.

6. The 3D space rendering system of claim 1, wherein the headset further has a fine-tuning mechanism.

7. The 3D space rendering system of claim 1, wherein the headset further has a resilient mechanism.

8. The 3D space rendering system of claim 1, wherein the first image capturing device and the second image capturing device are so disposed that they overlap each other.

9. The 3D space rendering system of claim 1, wherein the headset further has a projection light source for projecting a specific pattern or specific lines.

10. The 3D space rendering system of claim 1, where the 3D software performs a process comprising the steps of:
initializing, which step is performed at time point T₀ and comprises synchronizing image coordinates of at least a T₀ first image of the first image capturing device and of at least a T₀ second image of the second image capturing device and generating T₀ real-time image coordinates and T₀ full-time-domain coordinates; and
generating full-time-domain images, which step is performed at each time point from time point T₁ to time point Tₙ and comprises the sub-steps of:
capturing a Tₙ image, which sub-step comprises capturing a Tₙ first image and a Tₙ second image by the first image capturing device and the second image capturing device respectively, at the time point Tₙ;
performing feature point analysis, which sub-step comprises reading the Tₙ first image and the Tₙ second image and generating a plurality of Tₙ first feature points of the Tₙ first image and a plurality of Tₙ second feature points of the Tₙ second image;
comparing minimum-distance features, which sub-step comprises performing minimum-distance comparison on the Tₙ first feature points and the Tₙ second feature points and generating a plurality of Tₙ real-time common feature points and Tₙ real-time image coordinates;
rendering a real-time 3D image, which sub-step comprises generating a Tₙ real-time 3D image from the Tₙ real-time common feature points and the Tₙ real-time image coordinates;
generating Tₙ full-time-domain coordinates, which sub-step comprises integrating Tₙ real-time device position information of the image capturing devices at the time point Tₙ with Tₙ₋₁ full-time-domain coordinates at time point Tₙ₋₁ to generate the Tₙ full-time-domain coordinates; and
generating a Tₙ full-time-domain image, which sub-step comprises incorporating the Tₙ real-time common feature points and the Tₙ real-time 3D image into the Tₙ full-time-domain coordinates to generate the Tₙ full-time-domain image.

11. The 3D space rendering system of claim 10, wherein the step of initializing comprises the sub-steps, to be performed at the time point T₀, of:
acquiring equipment data, which sub-step comprises acquiring equipment data of the first image capturing device and of the second image capturing device;
synchronizing timeline, which sub-step comprises synchronizing system timeline of the first image capturing device and of the second image capturing device;
performing feature point analysis, which sub-step comprises reading the T₀ first image of the first image capturing device and the T₀ second image of the second image capturing device, analyzing feature points of the T₀ first image and of the T₀ second image, and generating a plurality of T₀ first feature points of the T₀ first image and a plurality of T₀ second feature points of the T₀ second image;
comparing minimum-distance features, which sub-step comprises performing minimum-distance comparison on each pair of said T₀ first feature point and said T₀ second feature point and generating a plurality of T₀ real-time common feature points and the T₀ real-time image coordinates;
rendering a real-time 3D image, which sub-step comprises generating a T₀ real-time 3D image from the T₀ real-time common feature points and the T₀ real-time image coordinates;
generating the T₀ full-time-domain coordinates, which sub-step comprises generating the T₀ full-time-domain coordinates, along with a full-time-domain reference point and full-time-domain reference directions thereof, from T₀ real-time 3D device position information of the image capturing devices at the time point T₀; and
generating a T₀ full-time-domain image, which sub-step comprises generating the T₀ full-time-domain image for the time point T₀ by incorporating the T₀ real-time common feature points and the T₀ real-time 3D image into the T₀ full-time-domain coordinates.

12. The 3D space rendering system of claim 11, wherein the sub-step of acquiring equipment data comprises acquiring mobile phone data or mobile phone parameters from a database, the database is established in advance and contains said mobile phone data or said mobile phone parameters of various brands and various models, and said mobile phone data or said mobile phone parameters comprise mobile phone brands, mobile phone model numbers, mobile phone lens dimensions, mobile phone shell dimensions, and lens-to-shell distances.

13. The 3D space rendering system of claim 1, wherein the first image capturing device is coupled to the first support, and the second image capturing device is coupled to the second support.
